(19) United States
(12) Patent Application Publication
(10) Pub. No.: US 2026/0303579 A1
(43) Pub. Date: Oct. 1, 2026

(54) Privacy-Safe Clean Room Collaboration

(71) Applicant: LiveRamp, Inc., San Francisco, CA (US)

(72) Inventors: Shannon Duncan, Conway, AR (US); Varun Nair, Chicago, IL (US)

(21) Appl. No.: 19/479,524

(22) PCT Filed: May 1, 2024
(86) PCT No.: PCT/US2024/027261

§ 371 Date: Oct. 28, 2025

Related U.S. Application Data
(60) Provisional application No. 63/463,459, filed on May 2, 2023.

(51) Int. Cl. H04L 9/40; G06F 21/60

(52) U.S. Cl. CPC H04L 63/0428; G06F 21/602

(57) ABSTRACT

In a method to join data in a clean room, a third-party provider encrypts the data using a public key provided by a consumer. The provider passes its data for transcoding, and the identity provider converts the data to the consumers domain while also encrypting it. The provider passes this data into the clean room where the consumer queries on it and sees the overlap between the datasets. While querying, the consumer provides a key which decrypts the data. Alternatively, both the clean room provider and consumer pass a key to the identity provider, and the identity provider double encrypts the data, such that the data can only be used by the consumer within the clean room.

### BACKGROUND

A data clean room is a secure and controlled space within a cloud-computing environment that allows multiple parties to bring data together for joint analysis.

Data clean rooms allow for parties to collaborate using their separate data without a loss of privacy with respect to the data being used in the collaboration. For example, for the purposes of sending messages to a desired audience, the parties sending the messages may be provided with non-personally identifiable information (non-PII) to target a specific audience.

Participants in a data clean room sometimes need to use a third party provider's identifiers to find an overlap between the datasets of the clean room provider and consumer. These identifiers are used, for example, to uniquely identify particular persons and households within a universe of such entities in the respective datasets. However, the consumer of the clean room may not want its data to be visible to the provider of a clean room. Therefore, a method is needed to allow use of third-party identifiers within a clean room environment while protecting the privacy of data within the clean room.

References mentioned in this background section are not admitted to be prior art with respect to the present invention.

### SUMMARY

The present invention is directed to a privacy-safe way for providers of a clean room to use data pertaining to a consumer from an app, for example, and bring it into a clean room without giving up knowledge of its contents. Providers of a clean room calling an identity native app for data pertaining to a customer can bring the data into the clean room in a privacy-safe way such that the data contents are not exposed.

In order to achieve the objectives in certain embodiments of the invention, the third-party provider encrypts the data in a public key provided by the clean room consumer, so that the clean room provider can handle the data and bring it into a clean room but cannot actually see the data. The consumer may provide a key to the third-party provider or native app. The provider passes its data for transcoding, and the identity provider converts the data to the clean room consumer's domain while also encrypting it. The clean room provider can hence see the results but the results are not usable by it directly. Since the values are encrypted in the clean room consumer's key, the results, even though visible to the clean room provider, are meaningless to the provider as it cannot decipher the actual underlying values. It simply passes this data into the clean room where the consumer queries on it and sees the overlap between the datasets. While querying, the consumer provides a key which decrypts the data in the confines of the clean room.

In other embodiments of the present invention, both the clean room provider and consumer pass a key to the identity provider. The identity provider double encrypts the data, and the clean room provider-apart from passing in the data-also passes in its own key. The consumer can then enter queries similar to the previous scenario, but now both keys are needed for the data to be used in the clean room. As a result, the data can only be used by the consumer within the confines of the clean room.

In these embodiments, the native apps and clean rooms are software constructs provided by a Software as a Service (Saas) provider in a cloud computing-based environment. Although the computational details are obscured from the user by the SaaS service, these cloud computing systems use compute, storage, and network resources provided by a cloud compute and storage provider.

Existing methods for solving this problem use a third-party clean room, rather than operating in the consumer cloud environment. This requires significantly more network traffic between the participating entities. Subsequently, this ends up using more resources-compute, memory, and storage due to the overhead involved in coordinating between three entities. The present invention in certain embodiments improves on this prior art system by reducing the required network traffic and coordination between the provider and consumer of the clean room, and the provider of the identity resolution solution. By reducing this complexity, it reduces compute, memory, and storage costs associated with the use of a third-party clean room.

These and other features, objects and advantages of the present invention will become better understood from a consideration of the following detailed description of the preferred embodiments and appended claims in conjunction with the drawings as described following:

### DRAWINGS

FIG. 1 is an architectural diagram for a cloud computing environment used for an implementation of the present invention.

FIG. 2 is a swim lane diagram showing a method according to an embodiment of the invention using only a consumer key.

FIG. 3 is a swim lane diagram showing a method according to an embodiment of the invention using both a consumer key and a provider key.

FIG. 4 is an architectural diagram of a computing resource for implementing the cloud computing environment of FIG. 1.

### DETAILED DESCRIPTION

Before the present invention is described in further detail, it should be understood that the invention is not limited to the particular embodiments described, and that the terms used in describing the particular embodiments are for the purpose of describing those particular embodiments only, and are not intended to be limiting, since the scope of the present invention will be limited only by the claims.

A system that provides an embodiment of the invention utilizes native features of cloud-based data warehouse environments. In one example, a data warehouse using the Snowflake® SaaS platform from Snowflake Inc. is described.

The Snowflake® environment will be used in the following examples for clarity, although the invention is not so limited. Other SaaS cloud providers have similar features, and the invention may be implemented in alternative embodiments on other cloud provider infrastructure.

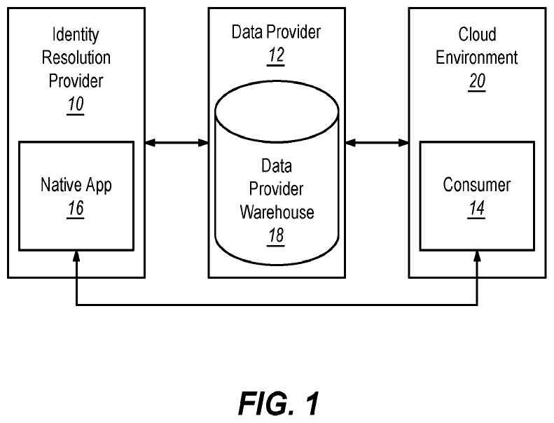

In an embodiment, the invention is implemented in a Snowflake® cloud-computing environment as depicted in FIG. 1. Snowflake® is a Software as a Service (Saas) provider. It abstracts away underlying cloud-provider details and splits them into the layers, thereby freeing the user from concern over implementational details. Snowflake® layers itself over any of three major cloud providers: Amazon AWS®, Microsoft Azure®, and Google® cloud. The database storage is backed by individual cloud providers storage; for example, on AWS® it could be an S3 bucket, and on Google® Cloud it would be a GCP bucket. The compute resources in the form of virtual warehouses are backed by compute resources on individual clouds. On top of these, Snowflake@ builds its cloud services which provide services such as security, SQL optimization, and so on. In the end, the user ends up using a Snowflake® managed interface to Snowflake-owned individual cloud provider accounts. The user interacts with this interface mostly using well-defined SQL commands, which Snowflake® translates to do individual tasks.

Snowflake® provides the capability to share data between different accounts through secure shares. It also provides the ability to share code/functionality directly between accounts through a database. To enable this functionality, Snowflake® allows a reference for the database to be passed to the consumer, such that certain functionality and data (as permissioned by the provider of the data) is visible to the consumer. The data does not move; Snowflake® simply permissions access to the data/functionality on the provider account to the consumer account. Compute resources get used on the consumer account.

The provider has the ability to remove access to a shared database within Snowflake®. Also, the functionality shared on the shared database is an interface to the user, but the user cannot see the details.

Native apps on Snowflake® are special data shares. Native apps allow stored procedures to be shared and some objects to be created at the consumer end. Data clean rooms are special native apps that have more privacy controls.

The parties in an exemplary data transaction as will be described below may be as follows, including a “consumer,” a “data provider,” and an “identity resolution provider.” A “consumer” is a party that owns certain data, and maintains that data in a cloud environment, such as may be facilitated by Snowflake®. This data may be of any type and used for any purpose. For example, the consumer may be a retailer that maintains data concerning its own customers, wherein each record in the consumer data set pertains to a particular customer, and each field contains particular data maintained related to that customer.

A “data provider” is a party that owns additional data that may be useful for the consumer in order to enhance the utility or functionality of its own data. This may be additional or updated data fields that pertain to the same data records maintained by the consumer in its own data set. In a non-limiting example, a consumer may be a retailer that maintains data about its own consumers, and a data provider may be a party that maintains comprehensive data concerning consumers across a particular geographical or geopolitical area, such as a particular country or region, and provides the service of enhancing retailer data with this additional data. Alternatively, the “data provider” may be another retailer, which has its own consumer data that could be considered as enhancement data from the point of view of the “consumer” in this scenario. The two parties may thus both be retailers that could benefit from collaborating with their data, but are otherwise limited by the need to protect the privacy of this data.

A third-party “identity resolution provider” may be a party that provides the service of resolving the identity of records that are ambiguous with respect to whether the records pertain to the same entity (e.g., consumer) or to different entities. Ambiguity is a common problem due to, for example, persons having the same name, persons changing names, typographical or other errors in the data, and the like. The identity resolution provider may maintain a set of identifiers or links that unambiguously are uniquely associated with particular entities within a possible data space, such as consumers within a particular jurisdiction. By applying these identifiers to the data of others, the identity resolution provider allows for the disambiguation of data within the data sets of other parties, since records pertaining to the same entity will receive a common identifier, whereas data pertaining to different entities will receive different identifier values.

FIG. 1 illustrates an architecture for an implementation of the methods described herein. Three computing environments are shown: these are computing environments for identity resolution provider 10, data provider 12, and cloud environment 20. Each of these computing environments may be implemented as computer hardware servers, multi-processor compute clusters, or the like. Identity resolution provider 10 provides native app 16, the function of which will be described below, and which may be installed in cloud environment 20 for execution by consumer 14. Native app 16 may be implemented in software that is executable within computing environments. Data provider warehouse 18 is used by data provider 12 to retrieve enhancement data for use by consumer 14. Data provider warehouse 18 may be implemented as solid-state computing storage, hard disk storage, or any other physical media storage technology for recording data and/or computing instructions. Consumer 14 itself is the computing and storage resources that are allocated to the consumer within cloud environment 20 by the SaaS cloud environment provider.

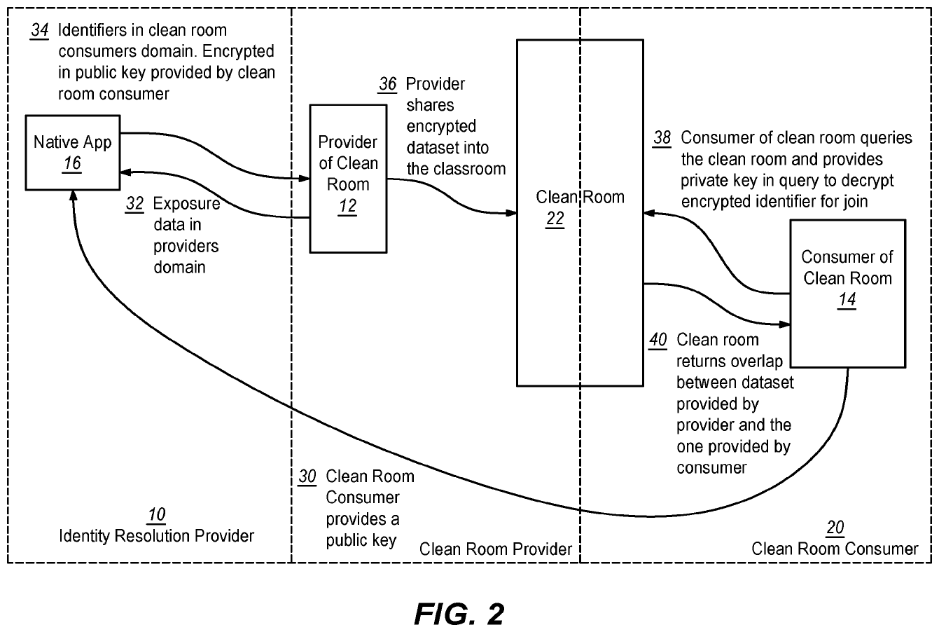

To utilize this architectural and data-sharing environment in an embodiment of the invention using only a consumer public key, the process proceeds as shown in FIG. 2. At step 30, the clean room consumer 14 shares a reference to a table in a schema of a database that contains the public key. The native app 16 uses compute resources at its account to read this key. At step 32, the native app 16 shares a reference to a database containing identity resolution logic to the clean room provider (data provider) 12. Exposure data is passed into these functions, which is a calculation of the amount of time users are shown or “exposed” to messages over a selected date range divided by the total engagement over the selected date range. Compute resources are used at the clean room provider 12 end to run the functionality shared by the native app 16. At step 34, the resulting dataset contains identifiers in the domain of the clean room consumer 14. The public key provided by the clean room consumer 14 is used to encrypt the dataset. This dataset takes up storage on the account of clean room provider 12. At step 36, the clean room provider 12 shares a reference to the dataset to the clean room consumer 14. It may be understood that in this case no data moves, just access is provisioned for the clean room consumer 14 to use the provider database 18. At step 38, the consumer of the clean room 14 queries the clean room 22 and provides a private key in the query to decrypt the encrypted identifier for the data join. Compute resources in this case are used on the consumer's end at clean room 14. At step 40, the clean room returns overlap between the dataset provided by the data provider 12 and the one provided by the consumer 14. This is stored as a dataset on the clean room consumer's end at consumer 14. In this way, data may be shared within the clean room 22 without a loss of privacy.

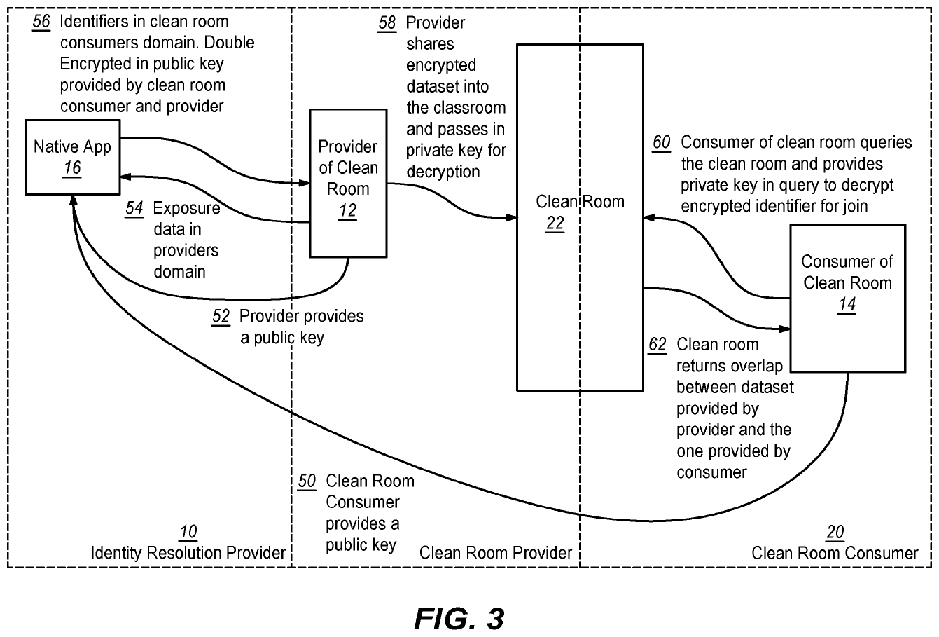

In FIG. 3, a variation of this method is shown that uses a public key from both the clean room data provider 12 and the clean room consumer 14. The identifiers are double encrypted in this case. Because both keys are used, the data can only be used by the consumer 14 within the confines of the clean room 22 itself. At step 50, the clean room consumer 20 provides a public key to native app 16, as in the process illustrated in FIG. 2. At step 52, however, data provider 12 also provides its own public key to native app 16. At step 54, the native app 16 shares a reference to a database containing identity resolution logic to the clean room provider (data provider) 12; as before in FIG. 2, exposure data is passed into these functions. Compute resources are used at the clean room provider 12 end to run the functionality shared by the native app 16. At step 56, the resulting dataset contains identifiers in the domain of the clean room consumer 14. Both of the encrypted public keys are provided by the clean room consumer 14 and the clean room provider 12. This dataset takes up storage on the account of clean room provider 12. At step 58, the clean room provider 12 shares a reference of the database to the clean room consumer 14, and also passes in a private key for decryption hidden from the clean room consumer but indirectly usable by a shared function/stored procedure. It may be understood that, as in the example of FIG. 2, in this case no data moves, just access is provisioned for the clean room consumer 14 to use the provider database 18. At step 60, the consumer of the clean room 14 queries the clean room 22 and provides its own private key in response to decrypt the encrypted identifier for the data join. Compute resources in this case are used on the consumer's end at clean room 14. At step 62, the clean room returns the overlap between the dataset provided by the data provider 12 and the one provided by the consumer 14. This is stored as a dataset on the clean room consumer's end at consumer 14. In this way, data may be shared within the clean room 22 without a loss of privacy. It will also be understood that since both keys are needed for decryption, the data may only be utilized within the confines of clean room 22.

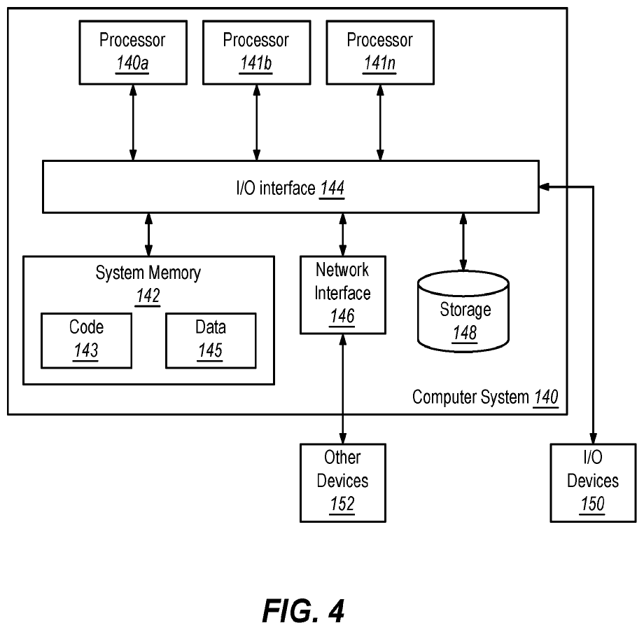

The methods described herein may in various embodiments be implemented by any combination of hardware and software. For example, in one embodiment, the methods may be implemented by a computer system (e.g., a computer system as in FIG. 4) or a collection of computer systems, each of which includes one or more hardware processors executing program instructions stored on a computer-readable physical storage medium coupled to the hardware processors, within the provider environment 12 and the customer environment 14. The program instructions may implement the functionality described herein (e.g., the functionality of various hardware servers and other components that implement the network-based cloud computing resources described herein). The various methods as illustrated in the figures and described herein represent example implementations. The order of any method may be changed, and various elements may be added, modified, or omitted.

FIG. 4 is a block diagram illustrating an example computer hardware system, according to various embodiments. Computer system 140 may implement a hardware portion of a cloud computing system, as forming parts of the various implementations of the present invention. Computer system 140 may be any of various types of hardware devices, including, but not limited to, a commodity server, mainframe computer system, workstation, network computer, application server, physical storage device, or in general any type of computing node, compute node, compute device, and/or hardware computing device.

Computer system 140 includes one or more hardware processors 140a, 141b . . . 141n (any of which may include multiple processing cores, which may be single or multi-threaded) coupled to a physical system memory 142 via an input/output (I/O) interface 144. Computer system 140 further may include a network interface 146 coupled to I/O interface 144. In various embodiments, computer system 140 may be a single processor system including one hardware processor 141a, or a multiprocessor system including multiple hardware processors 141a, 141b . . . 141n as illustrated in FIG. 4. Processors 141a, etc. may be any suitable processors capable of executing computing instructions. For example, in various embodiments, processors 141a, etc. may be general-purpose or embedded processors implementing any of a variety of instruction set architectures. In multiprocessor systems, each of processors 141a, etc. may commonly, but not necessarily, implement the same instruction set. The computer system 140 also includes one or more hardware network communication devices (e.g., network interface 146) for communicating with other systems and/or components over a communications network, such as a local area network, wide area network, or the Internet. For example, a client application executing on system 140 may use network interface 146 to communicate with a server application executing on a single hardware server or on a cluster of hardware servers that implement one or more of the components of the systems described herein in a cloud computing environment as implemented in various sub-systems. In another example, an instance of a server application executing on computer system 140 may use network interface 146 to communicate with other instances of an application that may be implemented on other computer systems.

In the illustrated embodiment, computer system 140 also includes one or more physical persistent storage devices 148 and/or one or more I/O devices 150. In various embodiments, persistent storage devices 148 may correspond to disk drives, tape drives, solid-state memory or drives, other mass storage devices, or any other persistent storage devices. Computer system 140 (or a distributed application or operating system operating thereon) may store instructions and/or data in persistent storage devices 148, as desired, and may retrieve the stored instructions and/or data as needed. For example, in some embodiments, computer system 140 may implement one or more nodes of a control plane or control system, and persistent storage 148 may include the solid-state drives (SSDs) attached to that server node. Multiple computer systems 140 may share the same persistent storage devices 148 or may share a pool of persistent storage devices, with the devices in the pool representing the same or different storage technologies, including such technologies as described above.

Computer system 140 includes one or more physical system memories 142 that may store code/instructions 143 and data 145 accessible by processor(s) 141a, etc. The system memories 142 may include multiple levels of memory and memory caches in a system designed to swap information in memories based on access speed, for example. The interleaving and swapping may extend to persistent storage devices 148 in a virtual memory implementation, where memory space is mapped onto the persistent storage devices 148. The technologies used to implement the system memories 142 may include, by way of example, static random-access memory (RAM), dynamic RAM, read-only memory (ROM), non-volatile memory, solid-state memory, or flash-type memory. As with persistent storage devices 148, multiple computer systems 140 may share the same system memories 142 or may share a pool of system memories 142. System memory or memories 142 may contain program instructions 143 that are executable by processor(s) 141a, etc. to implement the routines described herein.

In various embodiments, program instructions 143 may be encoded in binary, Assembly language, any interpreted language such as Java, compiled languages such as C/C++, or in any combination thereof; the particular languages given here are only examples. In some embodiments, program instructions 143 may implement multiple separate clients, server nodes, and/or other components.

In some implementations, program instructions 143 may include instructions executable to implement an operating system (not shown), which may be any of various operating systems, such as UNIX, LINUX, Solaris™, MacOS™, or Microsoft Windows™. Any or all of program instructions 143 may be provided as a computer program product, or software, that may include a non-transitory computer-readable storage medium having stored thereon instructions, which may be used to program a computer system (or other electronic devices) to perform a process according to various implementations. A non-transitory computer-readable storage medium may include any mechanism for storing information in a form (e.g., software or processing application) readable by a machine (e.g., a physical computer). Generally speaking, a non-transitory computer-accessible medium may include computer-readable storage media or memory media such as magnetic or optical media, e.g., disk or DVD/CD-ROM, coupled to or in communication with computer system 140 via I/O interface 144. A non-transitory computer-readable storage medium may also include any volatile or non-volatile media such as RAM or ROM that may be included in some embodiments of computer system 140 as system memory 142 or another type of memory. In other implementations, program instructions may be communicated using optical, acoustical or other form of propagated signals (e.g., carrier waves, infrared signals, digital signals, etc.) conveyed via a communication medium such as a network and/or a wired or wireless link, such as may be implemented via network interface 606. Network interface 146 may be used to interface with other devices 142, which may include other computer systems or any type of external electronic device.

In some embodiments, system memory 142 may include data store 145, as described herein. In general, system memory 142 and persistent storage 148 may be accessible on other devices 142 through a network and may store data blocks, replicas of data blocks, metadata associated with data blocks, and/or their state, database configuration information, and/or any other information usable in implementing the routines described herein.

In one embodiment, I/O interface 144 may coordinate I/O traffic between processors 141a, etc., system memory 142, and any peripheral devices in the system, including through network interface 146 or other peripheral interfaces. In some embodiments, I/O interface 144 may perform any necessary protocol, timing or other data transformations to convert data signals from one component (e.g., system memory 142) into a format suitable for use by another component (e.g., processors 141a, etc.). In some embodiments, I/O interface 144 may include support for devices attached through various types of peripheral buses, such as a variant of the Peripheral Component Interconnect (PCI) bus standard or the Universal Serial Bus (USB) standard, as examples. Also, in some embodiments, some or all of the functionality of I/O interface 144, such as an interface to system memory 142, may be incorporated directly into processor(s) 141a, etc.

Network interface 146 may allow data to be exchanged between computer system 140 and other devices attached to a network, such as other computer systems (which may implement one or more storage system server nodes, primary nodes, read-only node nodes, and/or clients of the database systems described herein), for example. In addition, I/O interface 144 may allow communication between computer system 140 and various I/O devices 150 and/or remote storage 148. Input/output devices 150 may, in some embodiments, include one or more display terminals, keyboards, keypads, touchpads, scanning devices, voice or optical recognition devices, or any other devices suitable for entering or retrieving data by one or more computer systems 140. These may connect directly to a particular computer system 140 or generally connect to multiple computer systems 140 in a cloud computing environment, grid computing environment, or other system involving multiple computer systems 140. Multiple input/output devices 150 may be present in communication with computer system 140 or may be distributed on various nodes of a distributed system that includes computer system 140. In some embodiments, similar input/output devices may be separate from computer system 140 and may interact with one or more nodes of a distributed system that includes computer system 140 through a wired or wireless connection, such as over network interface 146. Network interface 146 may commonly support one or more wireless networking protocols (e.g., Wi-Fi/IEEE 802.11, or another wireless networking standard). Network interface 146 may support communication via any suitable wired or wireless general data networks, such as other types of Ethernet networks, for example. Additionally, network interface 146 may support communication via telecommunications/telephony networks such as analog voice networks or digital fiber communications networks, via storage area networks such as Fibre Channel SANs, or via any other suitable type of network and/or protocol. In various embodiments, computer system 140 may include more, fewer, or different components than those illustrated in FIG. 4 (e.g., displays, video cards, audio cards, peripheral devices, or an Ethernet interface).

Any of the distributed system embodiments described herein, or any of their components, may be implemented as one or more network-based services in the cloud computing environment. For example, a read-write node and/or read-only nodes within the database tier of a hardware database system may present database services and/or other types of physical data storage services that employ the distributed storage systems described herein to clients as network-based services. In some embodiments, a network-based service may be implemented by a software and/or hardware system designed to support interoperable machine-to-machine interaction over a network. A web service may have an interface described in a machine-processable format. Other systems may interact with the network-based service in a manner prescribed by the description of the network-based service's interface. For example, the network-based service may define various operations that other systems may invoke, and may define a particular application programming interface (API) to which other systems may be expected to conform when requesting the various operations.

In various embodiments, a network-based service may be requested or invoked through the use of a message that includes parameters and/or data associated with the network-based services request. Such a message may be formatted according to a particular markup language such as Extensible Markup Language (XML), and/or may be encapsulated using a protocol. To perform a network-based services request, a network-based services client may assemble a message including the request and convey the message to an addressable endpoint (e.g., a Uniform Resource Locator (URL)) corresponding to the web service, using an Internet-based application layer transfer protocol such as Hypertext Transfer Protocol (HTTP).

Unless otherwise stated, all technical and scientific terms used herein have the same meaning as commonly understood by one of ordinary skill in the art to which this invention belongs. Although any methods and materials similar or equivalent to those described herein can also be used in the practice or testing of the present invention, a limited number of the exemplary methods and materials are described herein. It will be apparent to those skilled in the art that many more modifications are possible without departing from the inventive concepts herein.

All terms used herein should be interpreted in the broadest possible manner consistent with the context. When a grouping is used herein, all individual members of the group and all combinations and sub-combinations possible of the group are intended to be individually included. When a range is stated herein, the range is intended to include all sub-ranges within the range, as well as all individual points within the range. When “about,” “approximately,” or like terms are used herein, they are intended to include amounts, measurements, or the like that do not depart significantly from the expressly stated amount, measurement, or the like, such that the stated purpose of the apparatus or process is not lost. All references cited herein are hereby incorporated by reference to the extent that there is no inconsistency with the disclosure of this specification.

The present invention has been described with reference to certain preferred and alternative embodiments that are intended to be exemplary only and not limiting to the full scope of the present invention, as set forth in the appended claims.

We claim:

1. A method for data collaboration, comprising the steps of:
from a consumer computing environment, sharing a consumer public key across a network with a native app;
sharing a reference to an identity resolution logic database from the native app to a data provider computing environment to provide an identifier function;
at the data provider computing environment, allocating computing resources within the data provider computing environment and running the identifier function to generating an identifier dataset in the data provider computing environment;
at the native app, encrypting the identifier dataset with the consumer public key, and storing a resulting encrypted identifier dataset in a clean room, wherein the clean room comprises a secure and controlled space that allows multiple parties to bring data together for joint analysis;
sharing a reference to the encrypted identifier dataset with the consumer computing environment;
sending a query from the consumer computing environment to the clean room, wherein the query comprises a consumer private key; and
utilizing the consumer private key, decrypting the encrypted identifier dataset within the clean room to facilitate a data join.

2. The method of claim 1, further comprising the step of reading the consumer public key at the native app.

3. The method of claim 2, further comprising the step of sharing a set of exposure data from the data provider computing environment to the native app.

4. The method of claim 3, further comprising the step of storing the overlap at the consumer computing environment.

5. The method of claim 4, further comprising the step of returning from the clean room to the consumer computing environment an overlap between a data provider dataset and a consumer dataset.

6. The method of claim 1, further comprising the step of sending a provider public key from the provider computing environment to the native app.

7. The method of claim 6, further comprising the step of encrypting the identifier dataset with the provider public key.

8. The method of claim 7, further comprising the step of sharing a provider private key from the provider computing environment to the clean room.

9. The method of claim 8, wherein the step of decrypting the encrypted identifier dataset within the clean room to facilitate a data join utilizes both the consumer private key and the provider private key to decrypt the encrypted identifier dataset.

10. A machine comprising one or more computer processors and a memory space having instructions stored therein, the instructions, when executed by the one or more computer processors, causing the one or more computer processors to:
share a consumer public key from a consumer computing environment with a native app;
share a reference to an identity resolution logic database from the native app to a data provider computing environment to provide an identifier function;
allocate computing resources within the data provider computing environment and run the identifier function to generating an identifier dataset;
at the native app, encrypt the identifier dataset with the consumer public key, and store a resulting encrypted identifier dataset in a clean room;
share a reference to the encrypted identifier dataset with the consumer computing environment;
send a query from the consumer computing environment to the clean room, wherein the query comprises a consumer private key; and
utilizing the private key, decrypt the encrypted identifier dataset within the clean room to facilitate a data join.

11. The machine of claim 10, further comprising instructions, that when executed by the one or more computer processors, cause the one or more computer processors to share a set of exposure data from the data provider computing environment to the native app.

12. The machine of claim 11, further comprising instructions, that when executed by the one or more computer processors, cause the one or more computer processors to store the overlap at the consumer computing environment.

13. The machine of claim 10, further comprising instructions, that when executed by the one or more computer processors, cause the one or more computer processors to send a provider public key from the provider computing environment to the native app.

14. The machine of claim 13, wherein the instructions, when executed by the one or more computer processors, further encrypt the identifier dataset with the provider public key.

15. The machine of claim 14, further comprising instructions, that when executed by the one or more computer processors, cause the one or more computer processors to share a provider private key from the provider computing environment to the clean room.

16. The machine of claim 15, further comprising instructions, that when executed by the one or more processors, cause the one or more computer processors to decrypt the encrypted identifier dataset within the clean room to facilitate a data join utilizing both the consumer private key and the provider private key.

17. A computerized system for data collaboration, the system comprising:
an identity resolution computing environment comprising a native app, wherein the native app is configured to receive a consumer public key, share a reference to an identity resolution logic database to provide an identifier function, and to encrypt an identifier dataset with the consumer public key to produce an encrypted identifier dataset;
a data provider computing environment, wherein the data provider computing environment is configured to receive the reference to the identity resolution logic database and run an identifier function to generate the identifier dataset;
a consumer computing environment, wherein the consumer computing environment is configured to generate the consumer public key and to generate a query comprising a consumer private key; and
a clean room configured to receive the encrypted identifier dataset and to receive the query comprising the consumer private key to decrypt the encrypted identifier dataset within the clean room.

18. The computerized system of claim 17, wherein the data provider computing environment is further configured to share a set of exposure data with the native app.

19. The computerized system of claim 18, wherein the data provider computing environment is further configured to send a provider public key to the native app, and wherein the native app is further configured to encrypt the identifier dataset with the provider public key to produce a double encrypted identifier dataset.

20. The computerized system of claim 19, wherein the data provider computing environment is further configured to share a provider private key with the clean room, and wherein the native app is further configured to decrypt the double encrypted identifier dataset utilizing both the consumer private key and the provider private key, whereby the double encrypted identifier dataset may only be decrypted from within the clean room.
